(19) United States
(12) Patent Application Publication
(10) Pub. No.: US 2025/0362434 A1
(43) Pub. Date: Nov. 27, 2025

(54) EMBEDDED LENS STRUCTURES AND THE METHODS OF FORMING THE SAME

(71) Applicant: Taiwan Semiconductor Manufacturing Co., Ltd., Hsinchu (TW)

(72) Inventors: Zi-Jheng Liu, Taoyuan City (TW); Chiahung Liu, Hsinchu (TW); Ming-Fa Chen, Taichung City (TW)

(21) Appl. No.: 18/914,753

(22) Filed: Oct. 14, 2024

Related U.S. Application Data
(60) Provisional application No. 63/650,542, filed on May 22, 2024.

(51) Int. Cl. G02B 3/00

(52) U.S. Cl. CPC G02B 3/0012; G02B 3/0037

(57) ABSTRACT

A method includes forming a sacrificial layer on a substrate, and patterning the sacrificial layer to form a first sacrificial block having a first height, and a second sacrificial block having a second height greater than the first height. The second sacrificial block is spaced apart from the first sacrificial block by a space. The method further includes reflowing the first sacrificial block and the second sacrificial block, and performing an etching process to etch the first sacrificial block, the second sacrificial block, and the substrate. As a result of the etching, a first portion of the substrate directly underlying the first sacrificial block forms a micro lens, and a second portion of the substrate directly underlying the second sacrificial block forms a protection wall.

### PRIORITY CLAIM AND CROSS-REFERENCE

This application claims the benefit of the following provisionally filed U.S. Patent application: Application No. 63/650,542, filed on May 22, 2024, and entitled “EMBEDDED Si LENS STRUCTURE FORMATION FOR UNIFORMITY,” which application is hereby incorporated herein by reference.

### BACKGROUND

Electrical and optical signaling and processing are techniques for signal transmission and processing. Optical signaling and processing have been used in increasingly more applications in recent years, and have been typically combined with electrical signaling and processing to provide full-fledged applications. Packages thus may include both of optical (photonic) dies including optical devices and electronic dies including electronic devices.

Micro lenses are used for converging optical signal. Micro lenses may be formed by etching a transparent substrate, so that the surfaces of the etched portions of the transparent substrate are rounded.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1, 2A, 2B, 2C, 2D, 2E, 2F through FIGS. 7A, 7B, 7C, 7D, 7E, 7F, and 7G illustrate the views of intermediate stages in the formation of micro lenses in accordance with some embodiments.

FIGS. 8 through 9 illustrate the views of intermediate stages in the formation of micro lenses in accordance with alternative embodiments.

FIG. 10 illustrates a photonic package including a micro lens in accordance with some embodiments.

FIG. 11 illustrates a process flow for forming micro lenses in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “underlying,” “below,” “lower,” “overlying,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A micro lens structure and the method of forming the same are provided. In accordance with some embodiments of the present disclosure, the micro lens may be formed from a transparent substrate such as a silicon substrate. The formation process may include a single photolithography process (which may include one light-exposure process or two light-exposure processes, and one photo development process), and an etching process to etch the silicon substrate.

Embodiments discussed herein are to provide examples to enable making or using the subject matter of this disclosure, and a person having ordinary skill in the art will readily understand modifications that can be made while remaining within contemplated scopes of different embodiments. Throughout the various views and illustrative embodiments, like reference numbers are used to designate like elements. Although method embodiments may be discussed as being performed in a particular order, other method embodiments may be performed in any logical order.

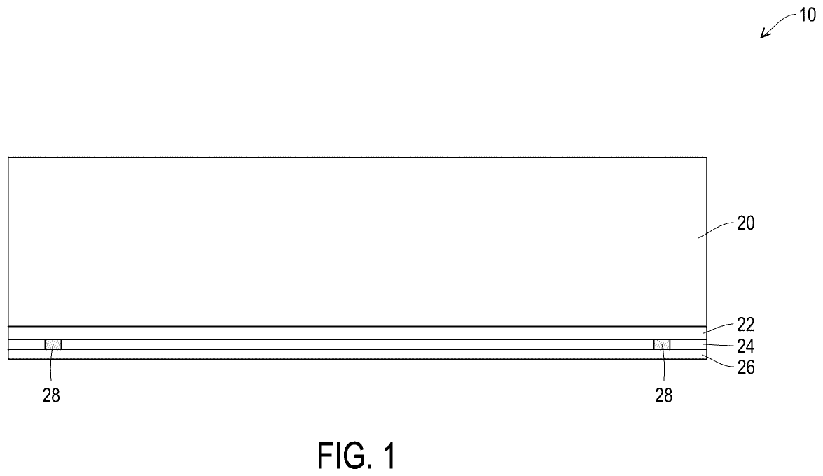

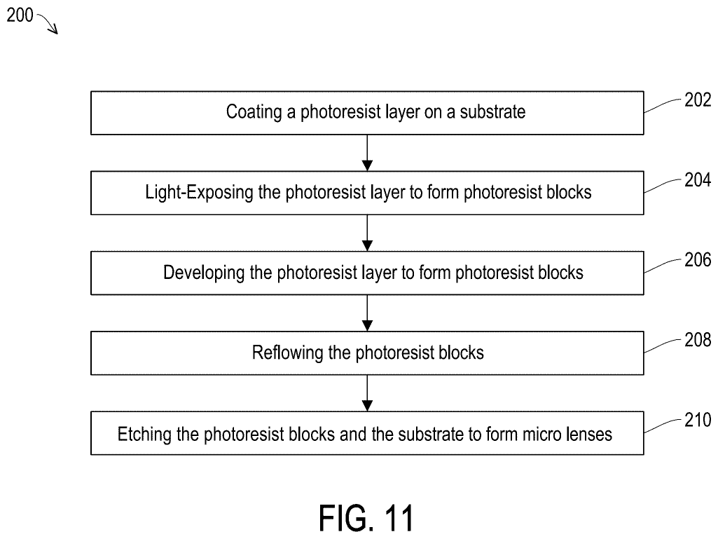

FIG. 1 through FIGS. 7A, 7B, 7C, 7D, 7E, 7F and 7G illustrate the views of intermediate stages in the formation of micro lenses in accordance with some embodiments of the present disclosure. The corresponding processes are also reflected schematically in the process flow 200 as shown in FIG. 11.

Referring to FIG. 1, wafer 10 is formed. Wafer 10 includes substrate 20. In accordance with some embodiments, wafer 10 is free from integrated circuit devices therein. For example, wafer 10 may not include any active devices (such as transistors) and passive devices (such as resistors, capacitors, inductors, or the like) therein. Substrate 20 may be a blanket transparent substrate formed of a homogeneous material such as silicon (doped or undoped), and there is no metal region, dielectric region, etc., therein.

In accordance with alternative embodiments, wafer 10 may be a device wafer that includes integrated circuit devices therein. For example, wafer 10 may include active devices such as transistors and passive devices such as resistors, capacitors, inductors, or the like therein. The active devices may be formed at the bottom surface of substrate 20, and additional features such as metal lines and dielectric layers may be formed under substrate 20 and electrically connecting to the integrated circuit devices. Passive devices may also be formed in the dielectric layers, and may or may not extend from the dielectric layers into substrate 20.

In subsequent discussion, it is assumed that wafer 10 is a blanket wafer that is free from active devices and passive devices therein. The discussion may also be applied to a device wafer when the micro lenses are to be formed directly in the semiconductor substrate of a device wafer.

Wafer 10 may include a plurality of dielectric layers such as layers 22, 24, and 26. In accordance with some embodiments, layer 22 may be formed of or comprise a dielectric material, which may be an oxide-based material such as silicon oxide, phospho-silicate glass (PSG), borosilicate glass (BSG), boron-doped phospho silicate glass (BPSG), fluorine-doped silicate glass (FSG), or the like. Layer 22 may be formed using spin coating, Flowable Chemical Vapor Deposition (FCVD), or the like.

In accordance with alternative embodiments of the present disclosure, layer 22 is formed by oxidizing a surface layer of substrate 20 to form a thermal oxide layer. In accordance with some embodiments, the entire layer 22 is formed of a homogeneous material, with no other material different from the homogeneous material therein.

Layer 24 may be formed of or comprise a dielectric material, which may be a nitride-based material such as silicon nitride, while it may also be formed of or comprise other materials such as silicon oxynitride (SiON).

In accordance with some embodiments, layer 26 is formed of or comprises a dielectric material, which may be an oxynitride based material such as silicon oxynitride (SiON), while it may also be formed of or comprises other materials such as silicon oxide, silicon oxycarbide (SiOC), silicon carbo-nitride (SiCN), or the like.

Alignment marks 28 may be formed in dielectric layers 22, 24, and/or 26, for example, in dielectric layer 24. In accordance with some embodiments, alignment marks 28 comprise a metal, a metal alloy, a metal compound, etc., to increase the contrast of alignment marks 28 relative to the surrounding materials. In accordance with some embodiments, alignment marks 28 comprise metal regions formed of or comprising copper, a copper alloy, tungsten, nickel, and/or the like. An adhesion layer may or may not be formed underlying and lining the metal regions. The adhesion layer may be formed of or comprise titanium, titanium nitride, tantalum, tantalum nitride, or the like.

The formation process of alignment marks 28 may include etching the respective dielectric layer (such as dielectric layer 24) to form openings, depositing the adhesion layer (if formed) as a conformal layer, for example using Physical Vapor Deposition (PVD), depositing the metallic material over the adhesion region, and then performing a Chemical Mechanical Polish (CMP) process to remove excess portions of the adhesion layer and the metallic material, leaving alignment marks 28 in dielectric layer 24.

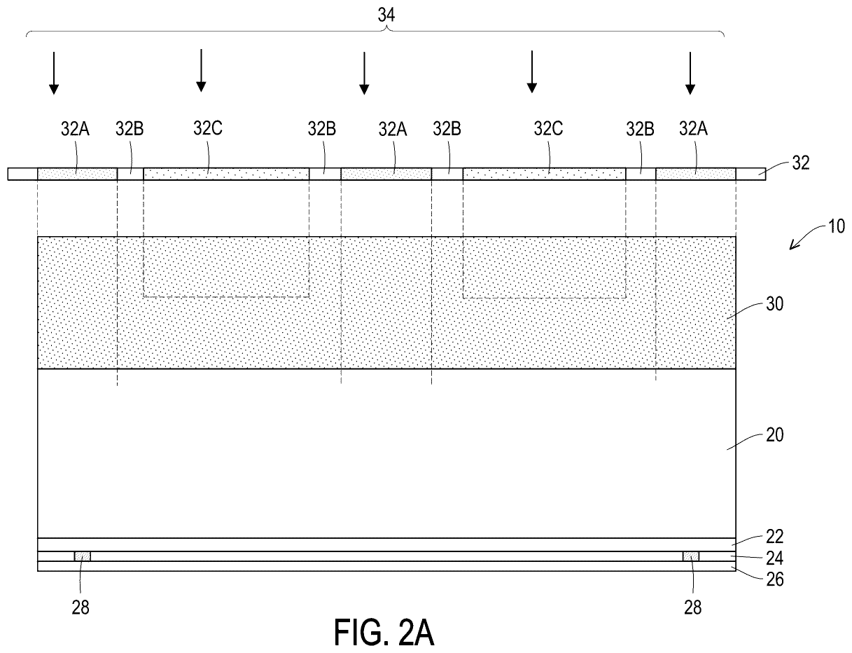

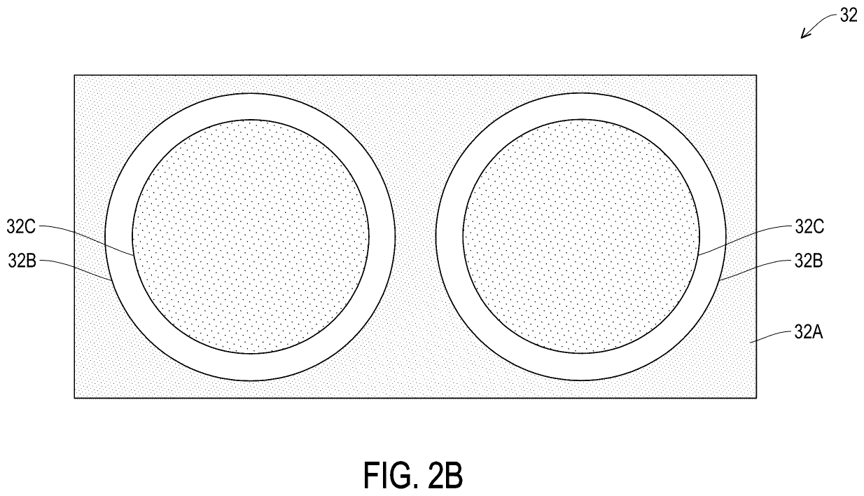

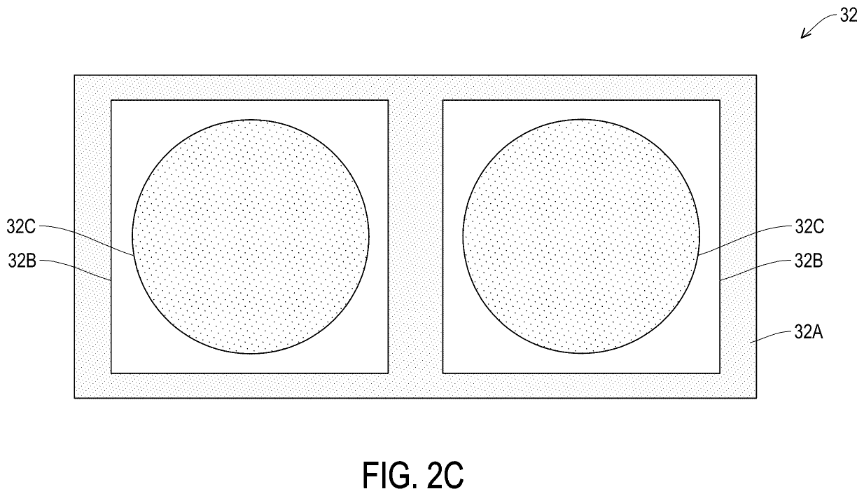

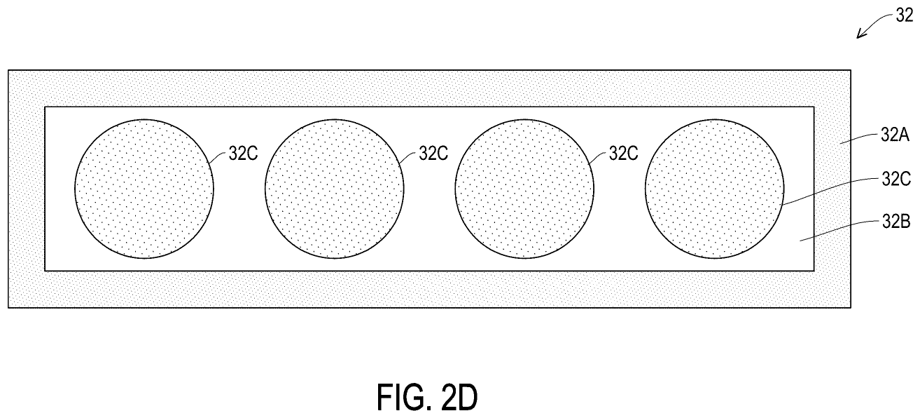

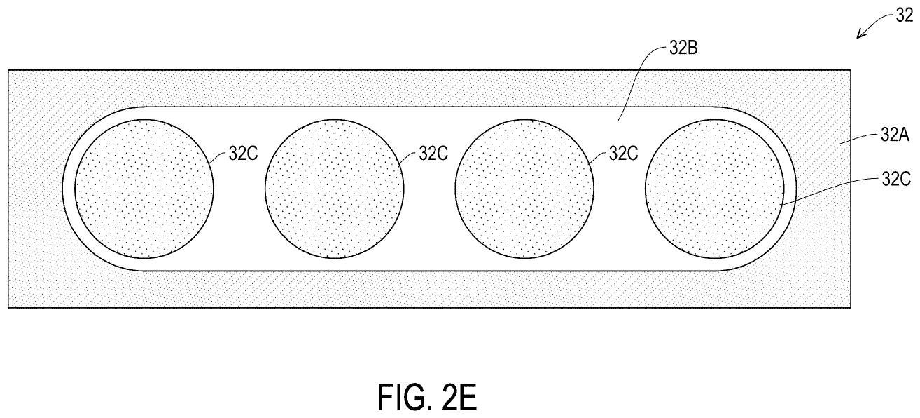

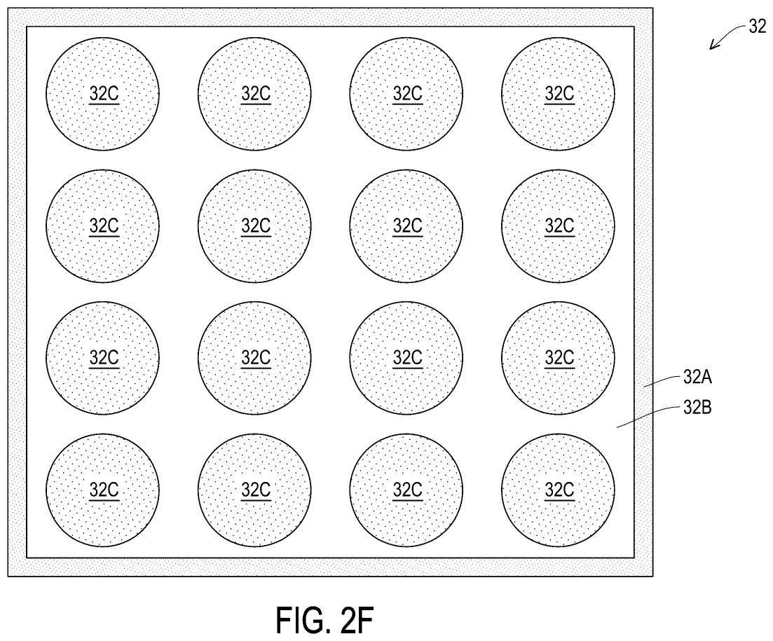

Referring to FIG. 2A, a photoresist layer 30 is coated on substrate 20. The respective process is illustrated as process 202 in the process flow 200 as shown in FIG. 11. In accordance with some embodiments, the photoresist layer 30 is formed of a material that is capable of being reflowed at an elevated temperature. After the coating of photoresist layer 30, photoresist layer 30 is soft baked to drive out solvents and hardened.

In accordance with some embodiments, before photoresist layer 30 is coated, an entire top surface of substrate 20 is exposed, and there is no additional layer and material such as oxide layer contacting the top surface of substrate 20. There is also no deposited layer between photoresist layer 30 and substrate 20.

In accordance with some embodiments, before photoresist layer 30 is coated, a cleaning process may be performed to remove any nature oxide on the top surface of substrate 20. The coated photoresist layer 30 may be on the exposed top surface of substrate 30, with no oxide in between. The cleaning process may be performed through a dry etching process, and the coating of photoresist layer 30 may also be performed in a same vacuum chamber in which the cleaning process is performed, with no vacuum break in between.

In accordance with alternatively embodiments, a nature oxide layer may be before photoresist layer 30 and substrate 20, and there is no other layer deposited on substrate 20 and between photoresist layer 30 and substrate 20. The thickness of the of the nature oxide layer, if existing, may have a thickness smaller than about 2 nm.

Lithography mask 32, which is a gray-tone lithography mask, is placed over the photoresist layer 30. In accordance with some embodiments, photolithography mask 32 comprises a plurality of opaque portions 32A, a plurality of transparent portions 32B, and a plurality of partially transparent portions 32C. Throughout the description, the transparency TP of an object is calculated as the ratio of the power of the light passing through an object to the power of the light incident on the object.

In accordance with some embodiments, the opaque portions 32A are fully opaque with transparency TP_{32A} being equal to zero percent or close to zero percent (for example, lower than about 10 percent or 5 percent). The transparent portions 32B may be fully transparent with transparency TP_{32B} being equal to 100 percent or close to 100 percent (for example, higher than about 90 percent or 95 percent). Partially transparent portions 32C have a transparency TP_{32C} greater than transparency TP_{32A} and lower than transparency TP_{32B}d. Each of the transparency differences (TP_{32B}-TP_{32C}) and (TP_{32C}-TP_{32A}) may be greater than about 10 percent, and may be in the range between about 20 percent and about 80 percent.

A light-exposure process 34 is performed to light-expose photoresist layer 30. The dosage of the light is controlled so that the portions of the photoresist layer 30 directly underlying the partially transparent portions 32C have their top portions adequately exposed, while the bottom portions are not adequately exposed. The portions of the photoresist layer 30 directly underlying the transparent portions 32C are adequately exposed. The entire portions of the photoresist layer 30 directly underlying the opaque portions 32C are not exposed. Throughout the description, an adequately exposed photoresist will be removed in a development process, while an unexposed or an un-adequately exposed photoresist will remain after the development process.

FIGS. 2B, 2C, 2D, 2E, and 2F illustrate the top views of some example photolithography mask 32 in accordance with some embodiments. Referring to FIG. 2B, a plurality of partially transparent portions 32C are spaced apart from each other. Each of the plurality of partially transparent portions 32C is surrounded by a transparent portion 32B, which is further surrounded by an opaque portion 32A, which surrounds all of the transparent portion 32B.

FIG. 2C illustrates a photolithography mask 32 in accordance with alternative embodiments. The photolithography mask 32 in accordance with these embodiments is essentially the same as that in FIG. 2B, except the transparent portions 32B in FIG. 2B have round top-view shapes, while the transparent portions 32B in FIG. 2C may have square top-view shapes. In accordance with other embodiments, the transparent portions 32B may have other shapes such as hexagons, octagons, ovals, or the like.

In FIGS. 2B and 2C, each partially transparent portion 32C is surrounded by a discrete transparent portion 32B. FIG. 2D illustrates a photolithography mask 32 in accordance with alternative embodiments. A common transparent portion 32B surrounds a plurality of partially transparent portions 32C, which may be aligned as a row in accordance with some embodiments.

FIG. 2E illustrates a photolithography mask 32 in accordance with yet alternative embodiments. The photolithography mask 32 in accordance with these embodiments is essentially the same as that in FIG. 2D, except the transparent portion 32B in FIG. 2D has a rectangular top-view shape, while the transparent portion 32B in FIG. 2E has a bean pod shape.

FIG. 2F illustrates a photolithography mask 32 in accordance with alternative embodiments. In accordance with some embodiments, a common transparent portion 32B surrounds a plurality of partially transparent portions 32C that are aligned as a plurality of rows and columns, which may be formed as an array, a honeycomb patterned, or the like.

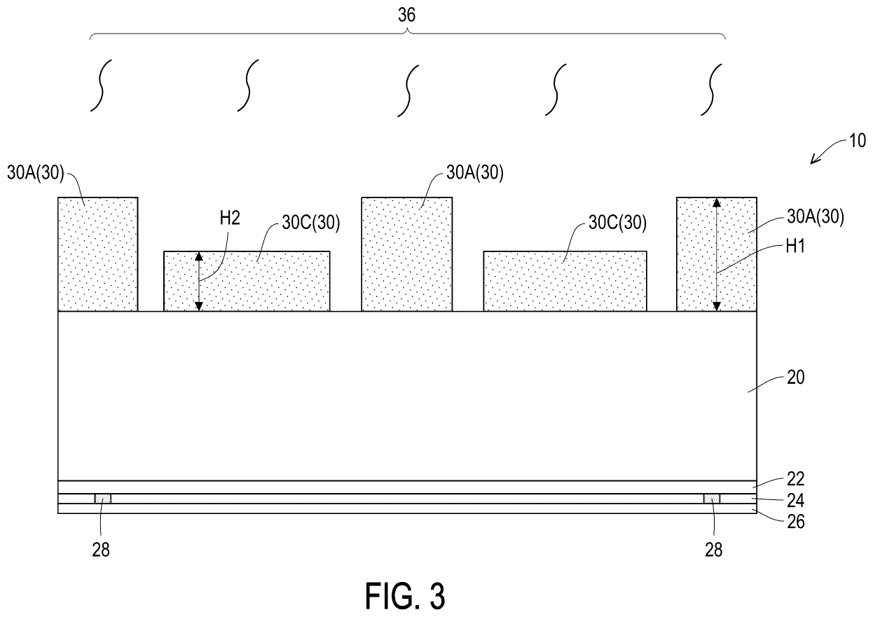

After the light-exposure process 34, the light-exposed photoresist layer 30 may or may not be hard baked. A development process is then performed to remove the exposed portions of the photoresist layer 30. The resulting structure is shown in FIG. 3. The respective process is illustrated as process 206 in the process flow 200 as shown in FIG. 11. The remaining portions of photoresist layer 30 are referred to as photoresist blocks 30 hereinafter. Photoresist blocks 30 will be etched in subsequent process, and thus also act as, and are referred to as, sacrificial blocks 30.

Photoresist blocks 30 include photoresist blocks 30A and photoresist blocks 30C. Photoresist blocks 30A are the remaining portions of the photoresist 30 directly under the opaque portions 32A of the photolithography mask 32. Photoresist blocks 30A have height H1. Photoresist blocks 30C are the remaining portions of the photoresist 30 directly under the partially transparent portions 32C of the photolithography mask 32. The top portions of the photoresist 30 directly under the partially transparent portions 32C of the photolithography mask 32 are removed. Accordingly, Photoresist blocks 30C have height H2 smaller than height H1. The ratio H2/H1 may be in the range between about 10 percent and about 80 percent in accordance with some embodiments, depending on the desirable curvature of the subsequently formed micro lens. The ratio H2/H1 is further affected by the transparency TP_{32C}, and the greater the TP_{32C}, the smaller the ratio H2/H1, and the greater the curvature will be.

Further referring to FIG. 3, a reflow process 36 is performed. The respective process is illustrated as process 208 in the process flow 200 as shown in FIG. 11. The reflow process is performed at an elevated temperature that is higher than the softening temperature of the photoresist blocks 30. In accordance with some embodiments, the reflow process 36 is performed at a temperature in a range between about 155° C. and about 165° C. The reflow process 36 may be performed, for example, for a duration in a range between about 300 seconds and about 350 seconds. The actual temperature and duration are related to the material of photoresist blocks 30, and may be higher/longer or lower/shorter.

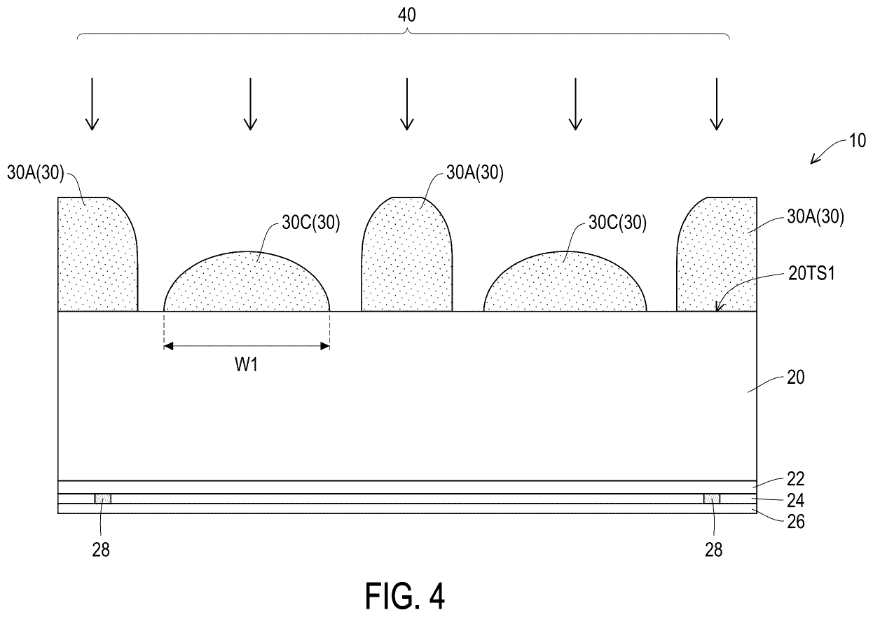

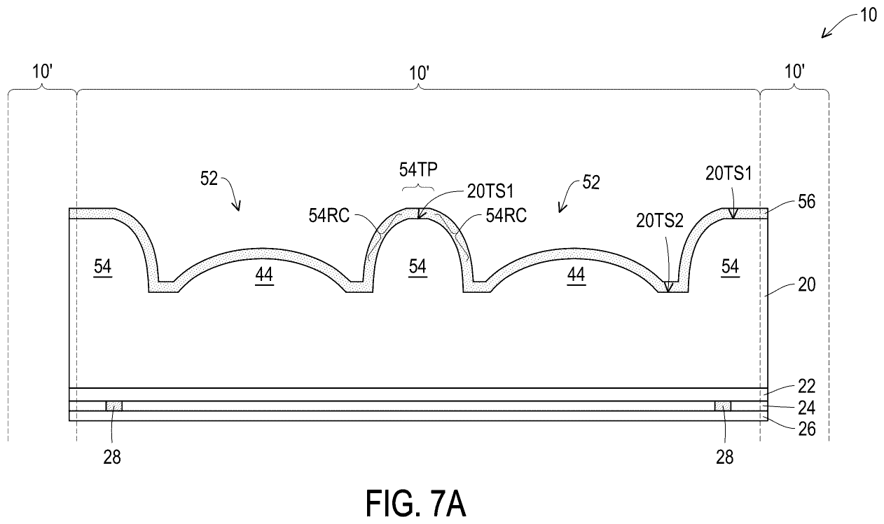

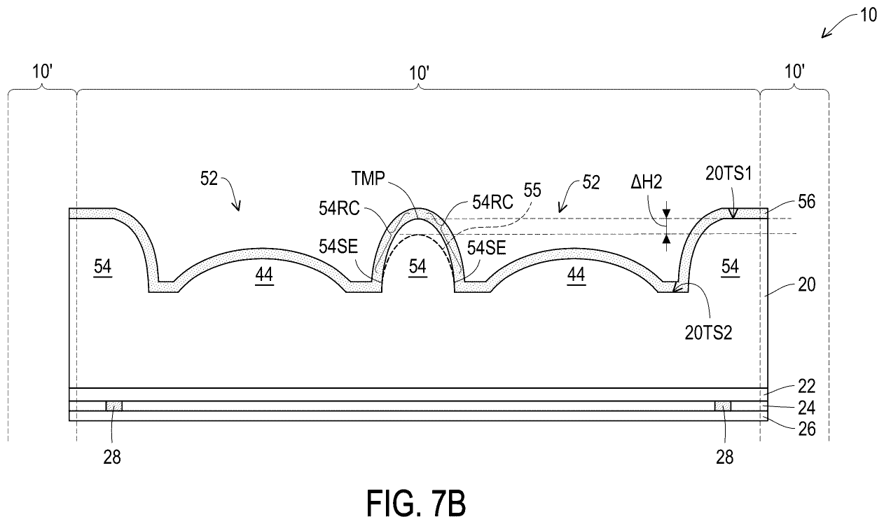

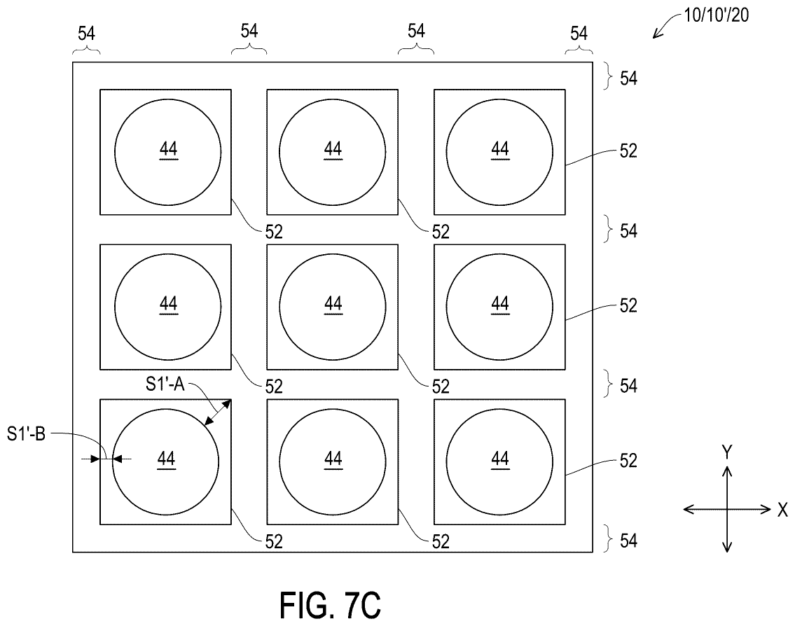

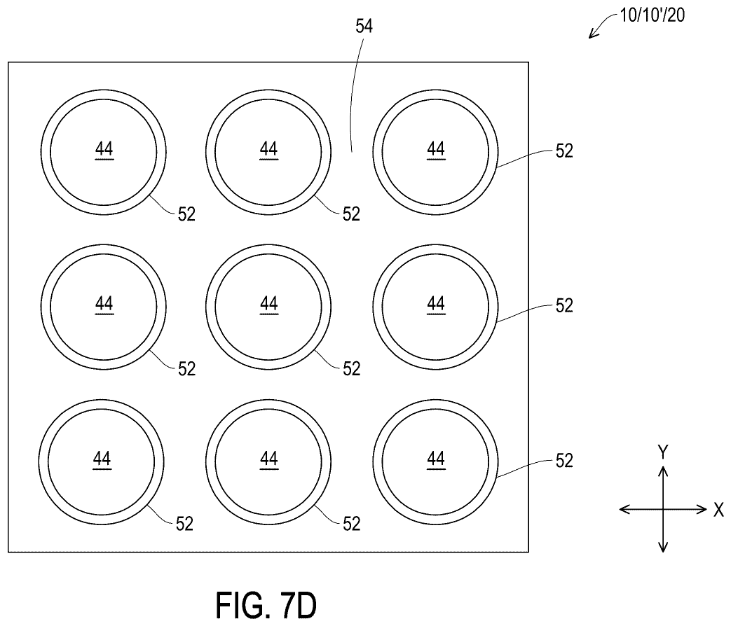

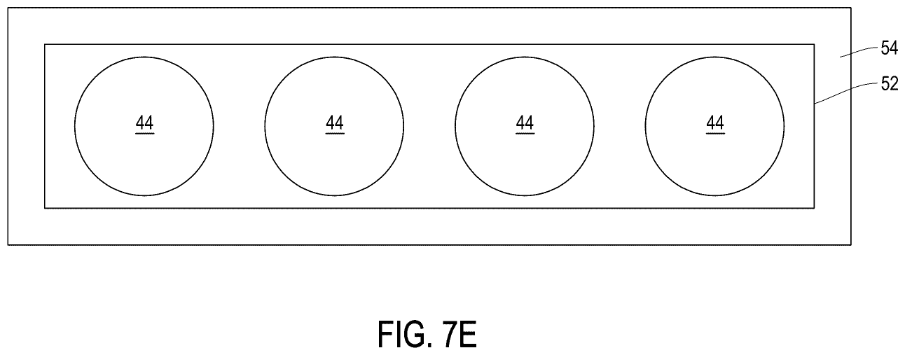

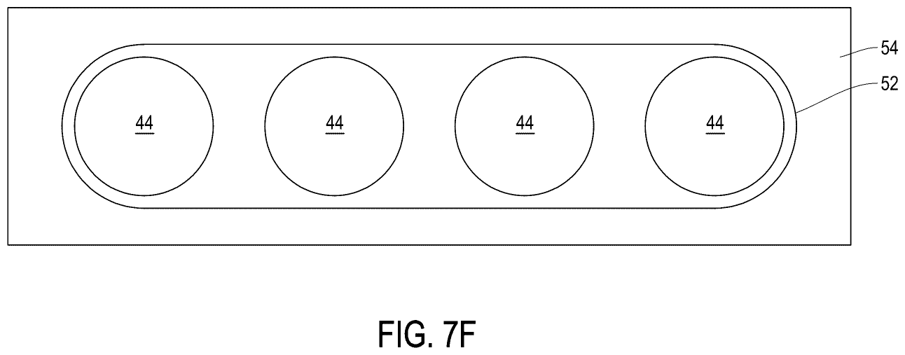

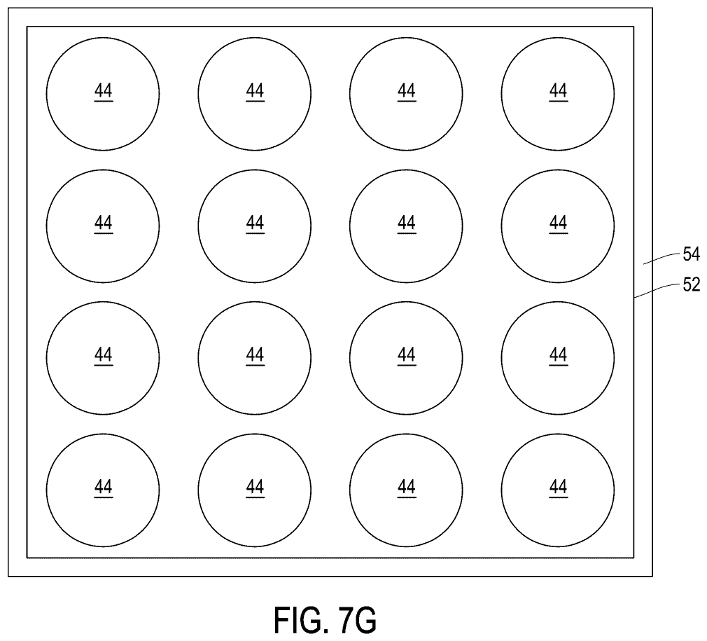

FIG. 4 illustrates the reflowed photoresist blocks 30A and 30C in accordance with some embodiments. The reflowed photoresist blocks 30C have rounded top surfaces. The reflowed photoresist blocks 30A have rounded corners, and some of the large photoresist blocks 30A may have planar top surfaces connecting to the rounded corners. The bottom portions of the sidewalls of photoresist blocks 30A may be straight and vertical, straight and slanted, or continuously curved. The upper portions of the sidewalls of photoresist blocks 30A are curved. Some small photoresist blocks 30A may also have all curved top surfaces (without having planar portions), which have a similar profile as dashed line 55 shown in FIG. 7B.

When viewed in a top view, the reflowed photoresist blocks 30C may be rounded. The top-view shape of the reflowed photoresist blocks 30C may be essentially the same as the top-view shape of the to-be-formed micro lenses 44 as shown in FIG. 7C. The top-view size of the reflowed photoresist blocks 30C may be the same as or slightly greater than or smaller than the top-view shape of micro lenses 44 as shown in FIG. 7C. The lateral dimension W1 of the reflowing photoresist blocks 30 (FIG. 4) may be in the range between about 100 μm and about 120 μm. The lateral dimension W1 may be a diameter since the reflowing photoresist blocks 30 may have circular top-view shapes.

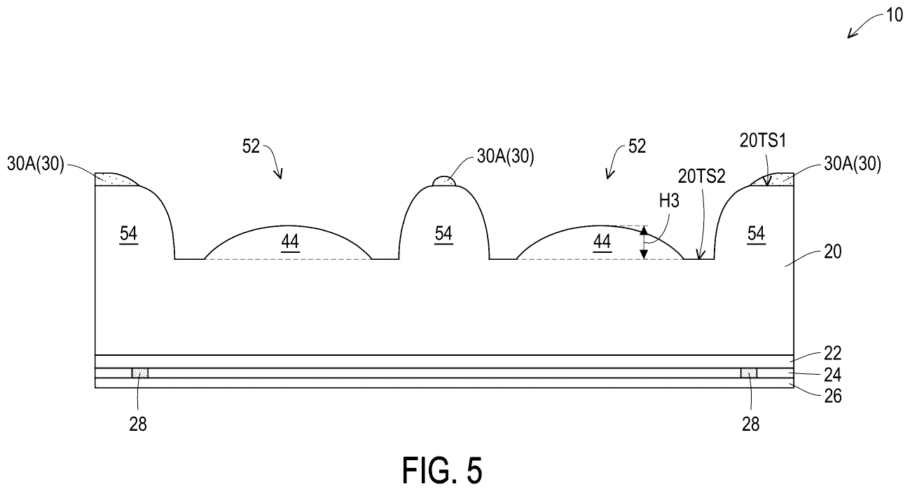

An etching process 40 is then performed (as shown in FIG. 4) to form micro lenses 44, which are shown in FIG. 5. The respective process is illustrated as process 210 in the process flow 200 as shown in FIG. 11. At the time the etching process 40 is started, the reflowed photoresist blocks 30 may be in physical contact with the material (such as silicon) of substrate 20. Alternatively, a very thin nature oxide layer may exist between the reflowed photoresist blocks 30 and substrate 20, with no deposited layer(s) on the nature oxide layer.

Etching process 40 is an anisotropic etching process, which is performed by using an etching gas that attacks both of substrate 20 and the reflowed photoresist blocks 30. The etching rate ER30 of the reflowed photoresist blocks 30 and the etching rate ER20 of substrate 20 may also be close to each other. For example, the etching rate ratio ER20/ER30 may be in the range between about 0.8 and about 1.2, and may be in the range between about 0.9 and about 1.1. In accordance with some embodiments, the etching process 40 is performed using an etching gas comprising NF₃, CO, O₂, CF₄, Cl₂, and/or the like.

With the proceeding of the etching process 40, both of the reflowed photoresist blocks 30 and the exposed portions of substrate 20 are etched down. With the proceeding of the etching process, increasingly more surface portions of the reflowed photoresist blocks 30 are consumed, exposing the surface portions of substrate 20 that are directly underlying the edge portions of the reflowed photoresist blocks 30, and the exposed portions of substrate 20 are also etched. More and more portions of substrate 20 directly under the reflowed photoresist blocks 30 are exposed and start to be etched. Accordingly, the shape and the surface profile of the reflowed photoresist blocks 30 are transferred into substrate 20.

As shown in FIG. 4, before the etching process 40 is started, substrate 20 has top surface 20TS1. The etching process 40 causes the reduction of the height of the planar top surface of some parts of substrate 20 to top surface 20TS2 as shown in FIG. 5. The top surfaces 20TS2 and 20TS1 have a height difference that is greater than the height H3 of micro lenses 44.

The etching process 40 is lasted until all of the reflowed photoresist blocks 30C are fully consumed. The reflowed photoresist blocks 30A, however, still have some portions left. In accordance with some embodiments, as shown in FIG. 5, the top surfaces of the etched portions of substrate 20 directly underlying photoresist blocks 30C are rounded, and hence forming micro lenses 44.

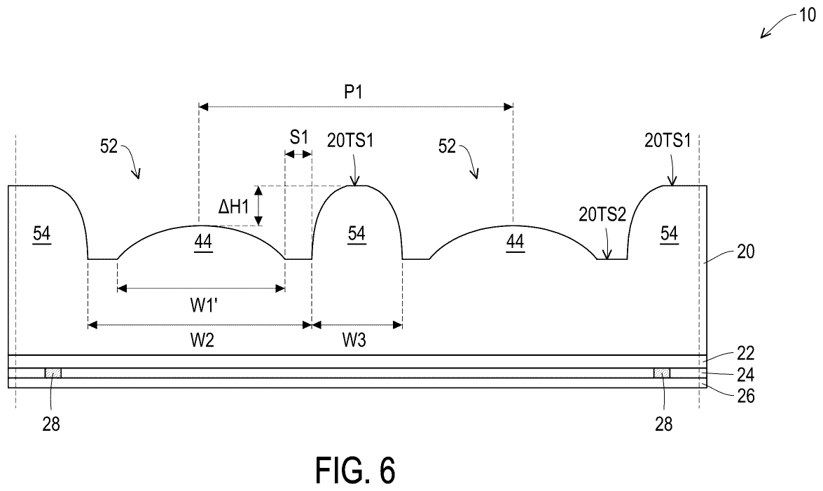

The remaining photoresist 30 is then removed, and the resulting structure is as shown in FIG. 6. Micro lenses 44 are formed in the recesses 52 of substrate 20. Substrate 20 includes protection walls 54. The protection walls 54 include the portion surrounding micro lenses 44, and the portions between, and separating neighboring recesses 52 and neighboring micro lenses 44 apart. In accordance with some embodiments, the top ends of micro lenses 44 are level with or lower than the top surfaces (which may be the un-recessed top surfaces 20TS1) of the protection walls 54. In accordance with some embodiments, the height difference ΔH1, which is the height difference between the topmost ends of micro lenses 44 and the top surface 20TS1, is greater than 0 μm and smaller than about 20 μm. With the difference ΔH1 being greater than 0 μm, the top ends of micro lenses 44 are recessed lower than the top surface 20TS1. Accordingly, when wafer 10 is flipped over and placed on other surfaces, micro lenses 44 will be higher than and spaced apart from the other surfaces, and will not be damaged.

The lateral dimension W1′ of micro lenses 44 may be a diameter since the reflowing photoresist blocks 30 may have circular top-view shapes. The lateral dimension W2 (or length or width) of the recesses 52 is smaller than the pitch P1 of micro lenses 44 to allow the space for the formation of protection walls 54. In accordance with some embodiments, the widths W3 of the protection walls 54 may be in the range between about 100 μm and about 300 μm, while greater or smaller widths may be adopted, depending on the application. The spacings S1 between the edges of micro lenses 44 and the corresponding nearest edges of protection walls 54 may be greater than about 0.1 μm, and may be in the range between about 0.1 μm and about 5 μm, and may also be in the range between about 1 μm and about 5 μm.

FIG. 7A illustrates the formation of protection layer 56 in accordance with some embodiments. Protection layer 56 may be formed of or comprise a transparent material such as silicon oxide, silicon oxy nitride, or the like. The formation process may include a conformal deposition process such as ALD, CVD, or the like. Alternatively, protection layer 56 may be formed through the thermal oxidation of substrate 20, for example, with silicon oxide being formed. A sawing process may then be formed to cut wafer 10 into dies 10′.

In accordance with some embodiments as shown in FIG. 7A, the top surfaces of protection walls 54 include planar portions 54TP, which are connected to the rounded corner surfaces 54RC. The planar portions 54TP may also be the original top surface 20TS1 of the substrate 20 before etching. Rounded corner surfaces 54RC are formed as a result of etching the corners of the substrate 20. The protection walls 54 may have vertical and straight edges under and connecting to the rounded corner surfaces 54RC. Alternatively, the continuous rounded corner surfaces 54RC are continuously curved, and extend from the top surface 20TS2 and all the way to the planar portions 54TP of the top surfaces of the protection walls 54.

In accordance with alternative embodiments as shown in FIG. 7B, the top surfaces of protection walls 54 do not include planar portions. Rather, the opposite rounded corner surfaces 54RC are joined at a topmost point TMP of the surface of protection wall 54, which topmost point TMP may be the middle point of the opposite edges of the protection wall 54. The protection walls 54 may have vertical and straight edges 54SE under and connecting to the rounded corner surfaces 54RC. Alternatively, the continuous rounded corner surfaces 54RC are continuously curved, and extend from the top surface 20TS2 all the way to the topmost point TMP of the top surfaces of the protection walls 54.

FIG. 7B also illustrates a protection wall 54 in accordance with alternative embodiments. When the photoresist blocks 30A for forming protection walls are narrow enough, these portions of the photoresist blocks 30A may be etched faster than the larger photoresist blocks 30A due to the sideway etching. As a result, these portions of photoresist blocks 30A may be fully removed, and the underlying protection walls 54 are also etched down. The top surfaces 55 (shown as being dashed) of the resulting protection walls 54 may also be rounded. Furthermore, the topmost end of the top surface 55 may be lower than the top surface 20TS1 by height difference ΔH2. Height difference ΔH2 is smaller than height difference ΔH1 (FIG. 6) in accordance with these embodiments.

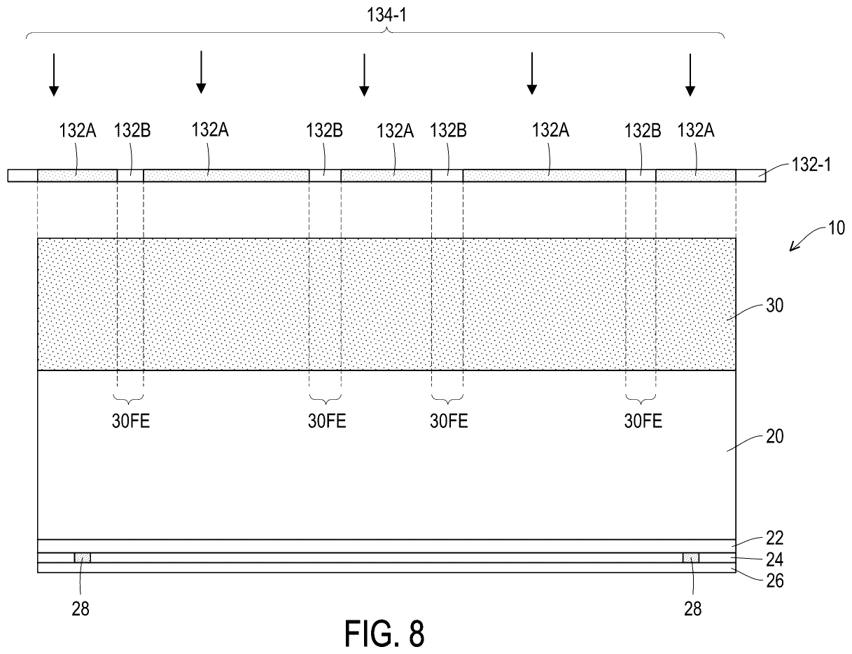

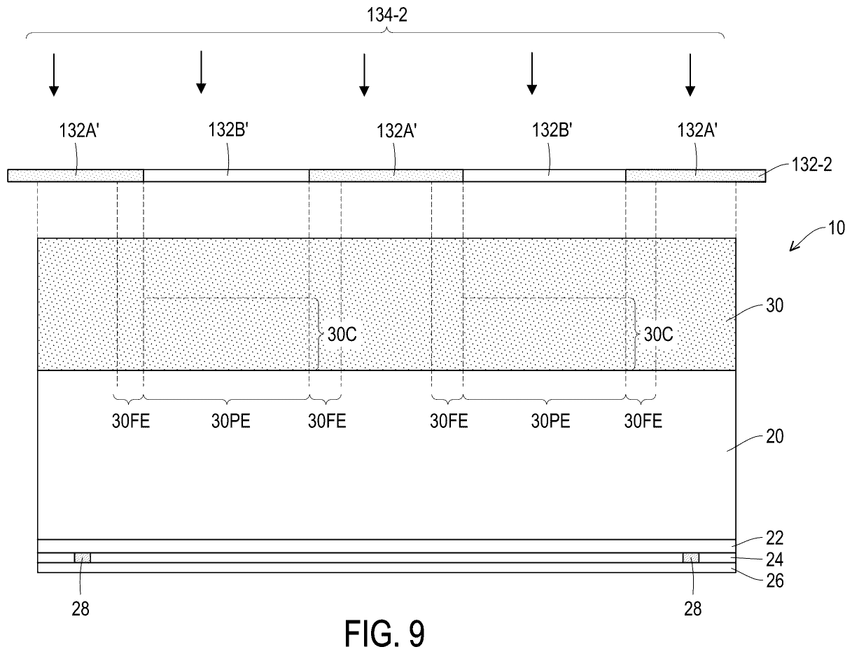

FIG. 7C illustrates a top view of a portion of wafer 10 and device die 10′ in accordance with some embodiments. Recesses 52 are formed as discrete recesses that are separated from each other by protection walls 54. In accordance with some embodiments, due to the use of gray-tone lithography masks (or two binary lithography masks as shown in FIGS. 8 and 9), recesses 52 have top view shapes different from the top-view shapes of the micro-lenses 44. For example, recesses 52 may have square top-view shapes, while lenses 44 may have circular top-view shapes.

In accordance with alternative embodiments, recesses 52 may have other top-view shapes including, and not limited to, circles, hexagons, octagons, or the like. As shown in FIG. 9C, the protection walls 54 form a grid, with recesses 52 being the grid openings of the grid. Micro lenses 44 are located at the centers of the recesses 52, or may be offset slightly to the same direction from the respective centers of the recesses 52.

In accordance with some embodiments, different portions of micro-lenses 44 may have different spacings from the nearest portions of the protection walls 54. For example, spacing S1′-A may be different from spacing S1′-B. Furthermore, recesses 52 may be concentric with the respective micro lenses 44 therein. Alternatively, the centers of recesses 52 to be eccentric with the centers of the respective micro lenses 44 therein.

FIG. 7D illustrates an embodiment in which recesses 52 also have circular top-view shapes. In accordance with some embodiments, micro lenses 44 have common centers with the respective recesses 52. Alternatively, the centers of recesses 52 may be slightly offset from the centers of the respective micro lenses 44 therein.

FIG. 7E illustrates an embodiment in which a single recess 52 has a plurality of micro lenses 44 therein. The plurality of micro lenses 44 are arranged as a row. The single recess 52 has a rectangular top-view shape.

FIG. 7F illustrates an embodiment in which a single recess 52 has a plurality of micro lenses 44 therein. The plurality of micro lenses 44 are arranged as a row. The single recess 52 has a pod top-view shape.

FIG. 7G illustrates an embodiment in which a single recess 52 has a plurality of micro lenses 44 therein. The plurality of micro lenses 44 are arranged as an array.

FIGS. 8 and 9 illustrate the formation of wafer 10 and die 10′ in accordance with alternative embodiments. These embodiments are essentially the same as that in the preceding embodiments, except that instead of using a grey-tone photolithography mask, two binary lithography masks are used. Unless specified otherwise, the materials, the structures, and the formation processes of the components in these embodiments are essentially the same as the like components denoted by like reference numerals in the preceding embodiments. The details regarding the materials, the structures, and the formation processes provided in each of the embodiments throughout the description may be applied to any other embodiment whenever applicable.

Referring to FIG. 8, wafer 10 is formed. The structure and the materials of wafer 10 are essentially the same as that are discussed referring to FIG. 1, and are not repeated herein. Photoresist layer 30 is coated on wafer 10. In accordance with some embodiments, the example embodiments shown in FIGS. 8 and 9 are discussed assuming the photoresist layer 30 is a positive photoresist, wherein the light-exposed portions will become soluble and will be removed when developed. In accordance with alternative embodiments, photoresist layer 30 may be a negative photoresist, and the corresponding process may be realized from the discussed embodiments.

As also shown in FIG. 8, a first photolithography mask 132-1 is placed over photoresist layer 30. Photolithography mask 132-1 is a binary mask, which includes opaque portions 134A and transparent portions 134B. The transparency of opaque portions 134A is equal to 0 percent or close to 0 percent (for example, lower than about 10 percent or 5 percent). The transparency of transparent portions 134B is equal to 100 percent or close to 100 percent (for example, greater than about 90 percent or 95 percent). The patterns of transparent portions 134B may be essentially the same as the patterns of transparent portions 32B as shown in FIG. 2B, 2C, 2D, 2E, or 2F.

A first light-exposure process 134-1 is performed. The portions 30FE of photoresist layer 30 directly underlying the transparent portions 32B are fully exposed from top to bottom, and are referred to as fully exposed portions 30FE. The dosage of the light for the light-exposure process 134-1 is high enough to achieve full exposure.

Referring to FIG. 9, a second photolithography mask 132-2 is placed over photoresist layer 30. Photolithography mask 132-2 is also a binary mask, which includes opaque portions 132A′ and transparent portions 132B′. The transparency of opaque portions 132A′ is equal to 0 percent or close to 0 percent (for example, lower than about 10 percent or 5 percent). The transparency of transparent portions 132B′ is equal to 100 percent or close to 100 percent (for example, greater than about 90 percent or 95 percent). The patterns of transparent portions 132B′ may be essentially the same as the patterns of the partially transparent portions 32C as shown in FIG. 2B, 2C, 2D, 2E, or 2F.

A second light-exposure process 134-2 is performed. The portions 30PE of photoresist layer 30 directly underlying the transparent portions 132B′ are partially exposed, and are referred to as partially exposed portions 30PE hereinafter. The top portions of the partially exposed portions 30PE are adequately exposed, and the bottom portions 30C of the partially exposed portions 30PE are inadequately exposed. The dosage of the light for the light-exposure process 134-1 is controlled to achieve the partial exposure. For example, the dosage of the light for the light-exposure process 134-1 may be controlled to be less than 80 percent, less than 50 percent, or lower, of the exposure dosage in the first light-exposure process 134-1.

In accordance with alternative embodiments, the order of the first light-exposure process 134-1 and the second light-exposure process 134-2 may be inversed than the order shown in FIGS. 8 and 9. In accordance with some embodiments, the edges of the fully exposed portions 30FE are aligned to the edges of the partially exposed portions 30PE, so that the fully exposed portions 30FE are joined to (but do not overlap) their neighboring partially exposed portions 30C. In accordance with alternative embodiments, the fully exposed portions 30FE slightly overlap their neighboring partially exposed portions 30PE. The overlapped portions are thus also fully exposed.

After the first light-exposure process 134-1 and the second light-exposure process 134-2, a development process is performed to remove the fully exposed portions 30FE and the top portions of the partially exposed portions 30PE. The resulting structure is shown in FIG. 3 also. The subsequent processes are essentially the same as the processes shown in FIGS. 3 through FIGS. 7A-7G, and are not repeated herein. The resulting structures are also essentially the same as shown in FIGS. 7A-7G.

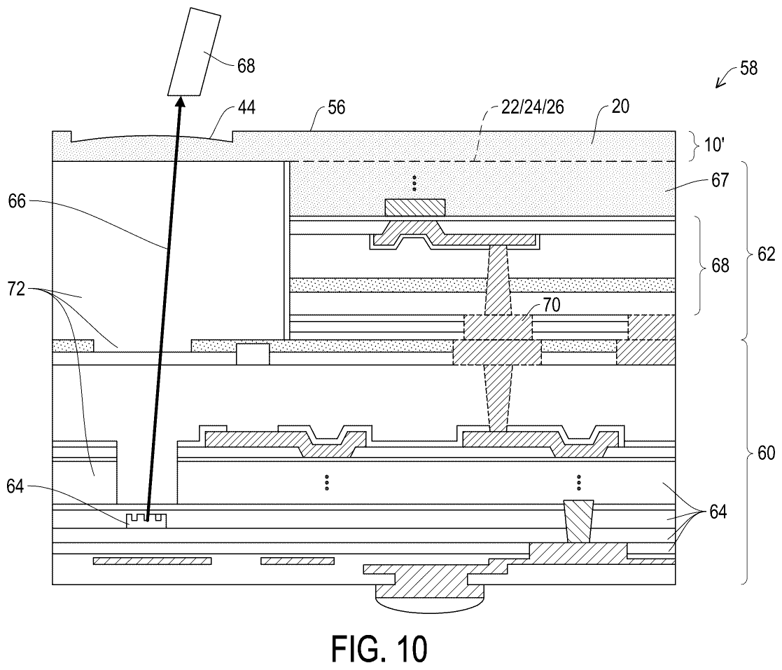

FIG. 10 illustrates a photonic package 58 in accordance with some embodiments, in which the die 10′ as shown in FIGS. 7A-7G are adopted. In accordance with some embodiments, photonic package 58 includes photonic die 60, electronic die 62 over and bonding to the photonic die 60, and die 10′ over and bonding to electronic die 62. The bonding of die 10′ to the electronic die 62 may be through fusion bonding, while the bonding of electronic die 62 to the photonic die 60 may be through hybrid bonding, which includes metal-to-metal direct bonding and fusion bonding.

In accordance with some embodiments, photonic die 60 may include photonic devices such as waveguides, grating couplers, edge couplers, modulators, and/or the like. For example, grating coupler 64 is illustrated as an example. The grating coupler 64 may be used for emitting or receiving a laser beam 66, which is emitted out of an optic fiber 68, or may be received by another coupler.

Electronic die 62 may be, for example, semiconductor devices, dies, or chips that communicate with photonic die 60 using electrical signals. Electronic die 62 includes semiconductor substrate 67, interconnect structure 68, and electrical connectors 70, which may be, for example, conductive pads, conductive pillars, or the like.

Electronic die 62 may include integrated circuits for interfacing with photonic die 60, such as the circuits for controlling the operation of photonic die 60. For example, electronic die 62 may include controllers, drivers, amplifiers, the like, or combinations thereof. Electronic die 62 may also include a CPU. In accordance with some embodiments, electronic die 62 includes the circuits for processing electrical signals received from photonic die 60. Electronic die 62 may also control high-frequency signaling of photonic die 60 according to electrical signals (digital or analog) received from another device or die, in accordance with some embodiments. In accordance with some embodiments, electronic die 62 may be an electronic integrated circuit (EIC) or the like that provides Serializer/Deserializer (SerDes) functionality. In this manner, electronic die 62 may act as part of an I/O interface between optical signals and electrical signals.

Die 10′ may have micro lenses 44, as discussed above. The formation process may be essentially the same as discussed in preceding embodiments. In accordance with some embodiments, the micro lenses 44 are formed after a reconstructed wafer is formed by bonding and encapsulating a plurality of electronic dies to a photonic wafer, and after wafer 10 (FIG. 1) is bonded to the reconstructed wafer. The processes of forming the micro lenses are performed on the resulting wafer that includes the wafer 10 and the reconstructed wafer. In accordance with alternative embodiments, the die 10′ are formed using the processes as discussed in preceding embodiments, and then the respective wafer 10 is bonded to a package (or a reconstructed wafer) that includes the photonic die(s) 60 and electronic die(s) 62.

The Micro lens 44 as shown in FIG. 10 has the function of converging laser beam 66, which travels through the transparent dielectric layers 72 in the optical path. Accordingly, optical fiber 68 and photonic die 64 are used to pass optical signals.

The embodiments of the present disclosure have some advantageous features. By adopting a one-photo-one-etching (1P1E) process to form micro lenses, the resulting wafer has reduced loss in thickness, which may be around 1 μm or less. The roughness of the micro lenses is low since the protection wall and the micro lenses are formed in a single etching process. The radius of curvature is controllable by adjusting the grey level (when using a grey-tone photolithography mask) or exposure dosage (when using two binary photolithography masks).

In accordance with some embodiments of the present disclosure, a method comprises forming a sacrificial layer on a substrate; patterning the sacrificial layer to form a first sacrificial block having a first height; and a second sacrificial block having a second height greater than the first height, wherein the second sacrificial block is spaced apart from the first sacrificial block by a space; reflowing the first sacrificial block and the second sacrificial block; and performing an etching process to etch the first sacrificial block, the second sacrificial block, and the substrate, wherein a first portion of the substrate directly underlying the first sacrificial block forms a micro lens, and a second portion of the substrate directly underlying the second sacrificial block forms a protection wall.

In an embodiment, when the etching process is ended, the second sacrificial block comprises a remaining part. In an embodiment, when the etching process is ended, the second sacrificial block has been removed to reveal a top surface of the substrate directly under the second sacrificial block. In an embodiment, the second sacrificial block is located in a position that is between the micro lens and a neighboring micro lens. In an embodiment, the forming the sacrificial layer comprises coating a photoresist layer. In an embodiment, the patterning the sacrificial layer comprises using a gray-tone lithography mask to light-expose the sacrificial layer; and developing the sacrificial layer.

In an embodiment, the gray-tone lithography mask comprises an opaque portion, wherein after the developing, a first part of the sacrificial layer directly underlying the opaque portion forms the second sacrificial block; a transparent portion, wherein after the developing, a second part of the sacrificial layer directly underlying the transparent portion is removed to leave the space; and a partially transparent portion, wherein after the developing, a third part of the sacrificial layer directly underlying the partially transparent portion remains as the first sacrificial block.

In an embodiment, the patterning the sacrificial layer comprises performing a first light-exposure process on the sacrificial layer using a first binary photolithography mask, wherein the first light-exposure process is performed with a first light dosage; and performing a second light-exposure process on the sacrificial layer using a second binary photolithography mask, wherein the second light-exposure process is performed with a second light dosage lower than the first light dosage. In an embodiment, the method further comprises a development process for developing the sacrificial layer that has been exposed using both of the first light-exposure process and the second light-exposure process. In an embodiment, the patterning the sacrificial layer is a single photolithography process.

In accordance with some embodiments of the present disclosure, a structure comprises a substrate; a micro lens at a surface of the substrate, wherein the micro lens comprises a transparent material, and the micro lens comprises a first top surface; and a protection wall comprising a first portion, wherein the first portion encircles the micro lens in a top view of the substrate, wherein the first portion comprises a second top surface higher than the first top surface, and wherein the protection wall is spaced apart from the micro lens by a space.

In an embodiment, the transparent material comprises silicon. In an embodiment, the structure further comprises a plurality of micro lenses at the surface of the substrate, wherein the protection wall comprises intermediate portions separating the plurality of micro lenses from each other. In an embodiment, the intermediate portions of the protection wall comprise third top surfaces coplanar with the first top surface.

In an embodiment, the intermediate portions of the protection wall comprise third top surfaces higher than the first top surface and lower than the second top surface. In an embodiment, a portion of the substrate directly underlying the space comprises a planar top surface. In an embodiment, the micro lens has different distances from respective parts of the first portion of the protection wall.

In accordance with some embodiments of the present disclosure, a structure comprises a photonic package comprising a photonic die; and an electronic die on the photonic die; and a transparent substrate over the photonic die, wherein the transparent substrate comprises a recess at a surface of the transparent substrate; a micro lens in the recess; and a portion of the transparent substrate surrounding the micro lens, wherein the micro lens is laterally spaced apart from nearest parts of the portion of the transparent substrate by spaces.

In an embodiment, the portion of the transparent substrate surrounding the micro lens forms a full ring, and wherein a first top-view shape of the full ring is different from a second top-view shape of the micro lens. In an embodiment, parts the substrate directly underlying the spaces comprise planar surfaces.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
forming a sacrificial layer on a substrate;
patterning the sacrificial layer to form:
a first sacrificial block having a first height; and
a second sacrificial block having a second height greater than the first height, wherein the second sacrificial block is spaced apart from the first sacrificial block by a space;
reflowing the first sacrificial block and the second sacrificial block; and
performing an etching process to etch the first sacrificial block, the second sacrificial block, and the substrate, wherein a first portion of the substrate directly underlying the first sacrificial block forms a micro lens, and a second portion of the substrate directly underlying the second sacrificial block forms a protection wall.

2. The method of claim 1, wherein when the etching process is ended, the second sacrificial block comprises a remaining part.

3. The method of claim 1, wherein when the etching process is ended, the second sacrificial block has been removed to reveal a top surface of the substrate directly under the second sacrificial block.

4. The method of claim 3, wherein the second sacrificial block is located in a position that is between the micro lens and a neighboring micro lens.

5. The method of claim 1, wherein the forming the sacrificial layer comprises coating a photoresist layer.

6. The method of claim 1, wherein the patterning the sacrificial layer comprises:
using a gray-tone lithography mask to light-expose the sacrificial layer; and
developing the sacrificial layer.

7. The method of claim 6, wherein the gray-tone lithography mask comprises:
an opaque portion, wherein after the developing, a first part of the sacrificial layer directly underlying the opaque portion forms the second sacrificial block;
a transparent portion, wherein after the developing, a second part of the sacrificial layer directly underlying the transparent portion is removed to leave the space; and
a partially transparent portion, wherein after the developing, a third part of the sacrificial layer directly underlying the partially transparent portion remains as the first sacrificial block.

8. The method of claim 1, wherein the patterning the sacrificial layer comprises:
performing a first light-exposure process on the sacrificial layer using a first binary photolithography mask, wherein the first light-exposure process is performed with a first light dosage; and
performing a second light-exposure process on the sacrificial layer using a second binary photolithography mask, wherein the second light-exposure process is performed with a second light dosage lower than the first light dosage.

9. The method of claim 8 further comprising a development process for developing the sacrificial layer that has been exposed using both of the first light-exposure process and the second light-exposure process.

10. The method of claim 1, wherein the patterning the sacrificial layer is a single photolithography process.

11. A structure comprising:
a substrate;
a micro lens at a surface of the substrate, wherein the micro lens comprises a transparent material, and the micro lens comprises a first top surface; and
a protection wall comprising a first portion, wherein the first portion encircles the micro lens in a top view of the substrate, wherein the first portion comprises a second top surface higher than the first top surface, and wherein the protection wall is spaced apart from the micro lens by a space.

12. The structure of claim 11, wherein the transparent material comprises silicon.

13. The structure of claim 11 further comprising a plurality of micro lenses at the surface of the substrate, wherein the protection wall comprises intermediate portions separating the plurality of micro lenses from each other.

14. The structure of claim 13, wherein the intermediate portions of the protection wall comprise third top surfaces coplanar with the first top surface.

15. The structure of claim 13, wherein the intermediate portions of the protection wall comprise third top surfaces higher than the first top surface and lower than the second top surface.

16. The structure of claim 11, wherein a portion of the substrate directly underlying the space comprises a planar top surface.

17. The structure of claim 11, wherein the micro lens has different distances from respective parts of the first portion of the protection wall.

18. A structure comprising:
a photonic package comprising:
a photonic die; and
an electronic die on the photonic die; and
a transparent substrate over the photonic die, wherein the transparent substrate comprises:
a recess at a surface of the transparent substrate;
a micro lens in the recess; and
a portion of the transparent substrate surrounding the micro lens, wherein the micro lens is laterally spaced apart from nearest parts of the portion of the transparent substrate by spaces.

19. The structure of claim 18, wherein the portion of the transparent substrate surrounding the micro lens forms a full ring, and wherein a first top-view shape of the full ring is different from a second top-view shape of the micro lens.

20. The structure of claim 17, wherein parts the substrate directly underlying the spaces comprise planar surfaces.
